(19) United States
(12) Patent Application Publication
(10) Pub. No.: US 2025/0122384 A1
(43) Pub. Date: Apr. 17, 2025

(54) Novel Compositions Particles, Powders, Pellets or Strands Coated With Discrete Carbon Nanotubes

(71) Applicant: Mechnano, LLC, Mesa, AZ (US)

(72) Inventors: Clive P. Bosnyak, Mesa, AZ (US); Steven Lowder, Mesa, AZ (US); Olga S. Ivanova, Mesa, AZ (US); Tanner Flake, Mesa, AZ (US)

(21) Appl. No.: 18/634,529

(22) Filed: Apr. 12, 2024

Related U.S. Application Data
(60) Provisional application No. 63/459,038, filed on Apr. 13, 2023.

(51) Int. Cl. C09D 5/03; C09D 7/40; C09D 7/45; C09D 7/61; C09D 7/65; C09D 171/00; C09D 177/04; C09D 177/06

(52) U.S. Cl. CPC C09D 5/031; C09D 5/035; C09D 7/45; C09D 7/61; C09D 7/65; C09D 7/70; C09D 171/00; C09D 177/04; C09D 177/06

(57) ABSTRACT

Novel compositions for producing particles, powders or strands with coatings of discrete carbon nanotubes wherein the coatings have a selected a range of porosity and the discrete carbon nanotubes have selected surface modifications to improve wetting or flow of material through the pores of the carbon nanotube coating. The coatings have less than about 20% mass of bundles or ropes of carbon nanotubes larger than about 5 micrometers thereby improving performance of the printed parts. The compositions may include coatings of a thickness from about 5 nanometers to about 5000 nanometers on particles of diameter less than about 5000 micrometers or polymer strands wherein the coating includes discrete carbon nanotubes and/or surface modification of the discrete carbon nanotubes.

### CROSS-REFERENCE TO RELATED APPLICATIONS

This application claims the benefit of U.S. Provisional Patent Application No. 63/459,038 filed Apr. 13, 2023.

### TECHNICAL FIELD

The present disclosure relates generally to novel compositions for producing additive manufacturing and molding feedstock laser sintering particles, powders or strands with coatings of discrete carbon nanotubes wherein the coatings have a selected range of porosity and thickness, and selected surface modifications to improve sintering, wetting or flow of material through the pores of the carbon nanotube coating. Furthermore, the coatings of carbon nanotubes comprise less than about 20% of the mass of the coating in the form of highly entangled bundles or ropes of carbon nanotubes wherein the bundles or ropes of carbon nanotubes have at least one dimension of size larger than about 5 micrometers.

### BACKGROUND AND SUMMARY

Additive Manufacturing (AM) is a suite of technologies that build 3-dimensional objects by processing a material in a layer-by-layer fashion. The material is generally, but not limited to, crosslinkable monomers or oligomers, thermoplastics, metals, ceramics, silicates, cements, and biological tissue. AM technologies commonly use a computer, 3D modeling software (Computer Aided Design-CAD), hardware equipment and feedstock material. After a CAD model of the part is produced, the AM hardware translates data from the CAD file and deposits material-liquid, powder, sheets or other form, in a layer-by-layer pattern to fabricate a 3D object. The term AM encompasses many technologies and is synonymous with 3D Printing, Rapid Prototyping, Direct Digital Manufacturing, layered manufacturing and additive fabrication. Material molding processes are a suite of technologies that form 3-dimensional objects by filling a mold cavity with a feedstock material that conforms to the shape of the mold thereby reproducing a positive shape of a negative mold geometry. The material is generally, but not limited to, crosslinkable monomers or oligomers, thermoplastics, metals, ceramic slurry, cements, and hydrogels.

Carbon nanotubes (CNTs) can be classified by the number of walls as single-wall, double wall and multiwall. Each wall of a CNT can be further classified into chiral or non-chiral forms. Some of the carbon atoms of the CNT may be substituted by nitrogen atoms. Some of the walls may contain Stone-Wales defects which are defined as heptagon-pentagon pairs. CNTs are currently manufactured at large tonnage using chemical vapor deposition reactors which produces agglomerated bundles or ropes of carbon nanotubes which have very limited commercial use due to their inferior performance as reinforcing fillers in the agglomerated state. Use of CNTs as a reinforcing agent or filler or conductive filler in polymer composites is an area in which CNTs are predicted to have significant utility if they can be made as discrete carbon nanotubes. However, utilization of CNTs in these applications has been hampered due to the general inability to reliably produce discrete or individualized CNTs.

Various methods have been developed to debundle or disentangle CNTs in different media. For example, CNTs may be shortened extensively by aggressive oxidative means and then dispersed as individual nanotubes in dilute solution. However, these tubes have low aspect ratios not suitable for high strength composite materials. CNTs may also be dispersed in very dilute solution as individual tubes by sonication in the presence of a surfactant. Illustrative surfactants used for dispersing CNTs in aqueous solution include, for example, sodium dodecyl sulfate, or cetyltrimethyl ammonium bromide. In some instances, solutions of individualized CNTs may be prepared from polymer-wrapped carbon nanotubes. Individualized single-wall CNT solutions have also been prepared in very dilute solutions using polysaccharides, polypeptides, water-soluble polymers, nucleic acids, DNA, polynucleotides, polyimides, and polyvinylpyrrolidone, but these dilute solutions are uneconomical to employ and unsuitable for large scale and additive manufacturing.

Numerous materials such as, but not limited to, crosslinkable monomers and oligomers that are crosslinked by such means as, but not limited to radiation or heat, thermosets and thermoplastic powders, thermoplastic pellets, gum stock rubbers, filaments, and metal injection molding materials, hot-melt plastic inks have been used in molding operations and AM; however, there remain many limitations of conventional molding and the AM materials properties such as rigidity, tear, heat distortion resistance, laser marking, rigidity, electrical conductivity for shielding of electromagnetic radiation or static electricity management, thermal transport, impact strength and deformation during processing. The need exists for particle coatings of discrete carbon nanotubes.

### BRIEF DESCRIPTION OF THE DRAWINGS

FIG. 1. An electron micrograph of a dried coating of discrete oxidized multiwall carbon nanotubes demonstrating the porosity of the coating and the presence of many open ends of the discrete oxidized carbon nanotubes.

FIG. 2. An electron micrograph at 50,000 magnification of discrete oxidized carbon nanotube coating on a powder particle of Vestasint 3054D. The discrete carbon nanotubes are coated with polyvinylpyrrolidone, molecular weight 10,000 daltons at 50% wt. relative to the discrete oxidized carbon nanotubes. The polyvinylpyrrolidone is seen as globules approximately 20 to 40 nanometers in diameter at the tube surface.

FIG. 3. An electron micrograph of 0.1% wt. coating of discrete carbon nanotubes on Vestasint 3054D. Magnification is 50,000×.

FIG. 4. A thermogram of Vestasint 3054D powders heating to sinter the particles, then cooling and reheating.

FIG. 5. A thermogram of Vestasint 3054D powders with a 2% wt. discrete multiwall carbon nanotube coating heating to sinter the particles, then cooling and reheating.

FIG. 6. Coating of discrete carbon nanotubes on Luvosint HTN particle. The coating is 0.25% wt. discrete oxidized carbon nanotubes with a polyvinylalcohol dispersant.

FIG. 7. Coating of discrete carbon nanotubes on Luvosint HTN particle. The coating is 0.5% wt. discrete oxidized carbon nanotubes with a polyvinylalcohol dispersant. The coating is partially removed from the powder surface of Lovosint HTN to determine the thickness of the coating.

### DETAILED DESCRIPTION OF THE INVENTION

In the following description, certain details are set forth such as specific quantities, sizes, etc., to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 3rd Edition, 2009. Definitions and/or interpretations should not be incorporated from other patent applications, patents, or publications, related or not.

Functionalized carbon nanotubes of the present disclosure generally refer to the modification of any of the carbon nanotube types described hereinabove, or hereafter. Such modifications can involve the nanotube ends, sidewalls inside and/or outside, or both. Modifications may include, but are not limited to covalent bonding, ionic bonding, chemisorption, intercalation, surfactant interactions, polymer wrapping, cutting, solvation, and combinations thereof. In some embodiments, the carbon nanotubes may be functionalized before, during and after being individualized or exfoliated.

Any of the aspects disclosed in this application with discrete carbon nanotubes may also be modified within the spirit and scope of the disclosure to substitute other tubular and non-tubular nanostructures, including, for example, organic, inorganic, or mineral nanotubes, planar nanostructures, and/or other nanostructures. Inorganic or mineral nanotubes include, for example, silicon nanotubes, boron nitride nanotubes and carbon nanotubes having heteroatom substitution in the nanotube structure. The nanotubes may include or be associated with organic or inorganic elements such as, for example, carbon, silicon, boron and nitrogen. Association may be on the interior or exterior of the inorganic or mineral nanotubes via Van der Waals, ionic or covalent bonding to the nanotube surfaces. Planar nanostructures include substantially planar carbon compounds such as graphene and similar structures composed of or including silicon, boron nitride, and carbon structures having heteroatom substitution in the nanostructure. These planar nanostructures may include or be associated with organic or inorganic elements such as, for example, carbon, silicon, boron and nitrogen. Association may be on either or both surfaces of the planar nanostructure via Van der Waals, ionic or covalent bonding to the planar nanostructure surfaces. Other nanostructures include three-dimensional carbon structures such as fullerenes and similar structures composed of or including silicon, boron nitride, and carbon structures having heteroatom substitution in the nanostructure. These other nanostructures may also include or be associated with organic or inorganic elements such as, for example, carbon, silicon, boron and nitrogen. Association may be on the interior or exterior of the nanostructure via Van der Waals, ionic or covalent bonding to the nanotube surfaces.

The general purpose of the novel composition, systems and methods disclosed herein is to provide materials for producing molding feedstock particles or powders with coatings of discrete carbon nanotubes. The coatings have a selected range of porosity and optionally selected surface modifications, to improve sintering, wetting or flow of material through the pores of the carbon nanotube coating. Furthermore, the coatings of carbon nanotubes comprise less than about 20% of the mass of the coating in the form of highly entangled bundles or ropes of carbon nanotubes wherein the bundles or ropes of carbon nanotubes have at least one dimension of size larger than about 5 micrometers. This composition is designed to work in conjunction with a large variety of manufacturing molding processes and techniques.

In one non-limiting embodiment, a composition of matter is configured for injection molding to form coatings by virtue of its component elements or a combination of component elements comprising the composition of matter. One general aspect includes a composition for AM or injection molding. The composition also includes coatings of a thickness from about 5 nanometers to about 5 micrometers on particles of diameter less than about 5 millimeters where the coating is selected from the group of discrete carbon nanotubes. In some embodiments the coating comprises a uniform distribution of carbon nanotubes which yield a coating in more uniform thickness of between 5 nanometers to 50 nanometers on a particle of diameter less than about 5 millimeters. Other embodiments of this aspect include corresponding coatings configured to perform the actions of the composition.

Implementations may include one or more of the following features. The composition where the particles or pellets are selected from the group of organic polymers and inorganic species. The organic polymers are selected from the group of elastomers with a glass transition temperature below about 25 degrees centigrade, and polymers with a glass transition temperature above about 25 degrees centigrade. The inorganic species are selected from the group consisting of ceramics, silicates, metals, metal oxides, metal salts, calcium carbonate, talc, magnesium carbonate, Wollastonite, glass beads, glass fibers, glass flakes, fly ashes, silica, dolomite, barium sulfate, aluminum hydroxide, halloysite, zinc oxide, titanium oxide, mica and hematite, and mixtures thereof. The coating has a porosity (porosity defined as void fraction or that fraction of open space relative to the whole volume of the carbon nanotube coating) of about 0.05 to about 0.95. In some embodiments the discrete carbon nanotubes comprise single wall carbon nanotubes. In some embodiments the discrete carbon nanotubes comprise double wall carbon nanotubes. In some embodiments the discrete carbon nanotubes comprise multiwall carbon nanotubes. In some embodiments the discrete carbon nanotubes are selected from a group of single wall, double wall or multiwall carbon nanotubes and mixtures thereof. The modality of aspect ratio of the discrete carbon nanotubes can be monomodal or at least bimodal. The carbon nanotubes are of length greater than about 0.2 micrometers. The discrete carbon nanotubes are preferably uniformly dispersed with less than about 20% of the mass of the carbon nanotubes present in the coating in the form of bundles or ropes of carbon nanotubes on a dimension scale larger than about 2 micrometers, more preferably less than about 5% of the mass of the carbon nanotubes present in the coating in the form of bundles or ropes of carbon nanotubes on a dimension scale larger than about 2 micrometers, and most preferably with less than 1% of the mass of the carbon nanotubes present in the coating in the form of bundles or ropes of carbon nanotubes on a dimension scale larger than about 2 micrometers. The composition may include carbonaceous material selected from the group of carbon black, carbon fibers, graphite, graphene, reduced graphene, carbon nanorods and graphene oxide. The ratio of discrete carbon nanotubes to carbonaceous material selected from the group of carbon black, carbon fibers, graphite, graphene, reduced graphene, carbon nanorods and graphene oxide is in the range about 1:99 to about 99:1 by weight. A part made by sintering particles, powders or strands with the coating compositions has a surface resistance of less than about 10 billion ohms. Implementations of the described techniques may include a variety of compositions or a method or process of preparing or applying the composition.

One general aspect includes a composition for injection molding. The composition also includes coatings of a thickness from about 5 nanometers to about 5 micrometers on particles of diameter less than about 5 millimeters where the coating is selected from the group of discrete carbon nanotubes may include surface modification of the discrete carbon nanotubes. Other embodiments of this aspect include corresponding compositions of matter configured to perform the actions of the methods.

Implementations may include one or more of the following features. The composition where the surface modification is attached to the surface of the discrete carbon nanotubes by covalent, ionic or hydrogen bonding. The discrete carbon nanotubes further may include a surface modification selected from the group of molecules containing oxygen, silicon, titanium, zirconium, sulfur, phosphorous or nitrogen. The discrete carbon nanotubes further may include a surface modification selected from the group of anionic, cationic, nonionic and zwitterionic surfactants, polyvinyl alcohols, copolymers of polyvinyl alcohols and polyvinyl acetates, polyvinylpyrrolidones and their copolymers, carboxymethyl cellulose, carboxypropyl cellulose, carboxymethyl propyl cellulose, hydroxyethyl cellulose, polyetherimines, polyethers, starch, and mixtures thereof. The surface modification has a value of Hansen Solubility Parameter dispersion parameter within about 2 J^{0.5} m^{-1.5} the value of the Hansen dispersion parameter of the particle or strand. The discrete carbon nanotube surface modification can be miscible with a polymer particle. The surface modification may also allow chemical interaction between the composition of the particle and the surface modification. For example, but not limited, the discrete carbon nanotubes can be oxidized to provide carboxylic acid groups which may react with a polyamide, or polyester, or inorganic particle. The surface modification can be at least partially removed, or partially modified, during sintering of the particle. With ceramics where sintering can occur at temperatures above the degradation temperature of the carbon nanotubes, the coatings can serve to provide sub-micrometer channels for gaseous transport.

In various embodiments, discrete, or individual, carbon nanotubes are disclosed comprising single wall, double wall or multi wall carbon nanotubes with length greater than about 200 nanometers. The aspect ratio is defined as the length of an individual carbon nanotube divided by its diameter. In some cases, the carbon nanotubes are not linear and so an effective aspect ratio can be defined as the effective length over the effective diameter. The effective aspect ratio is generally less in value than the actual aspect ratio of an individual carbon nanotube. To define the aspect ratio of a carbon nanotube requires determination of the length and diameter of the same carbon nanotube. In most cases there is a distribution of lengths and diameters which can be used to define a distribution of lengths, diameters, or aspect ratios. The single wall carbon nanotubes have strong energetics of association along their length and so easily form ropes containing many individual single wall carbon nanotubes. The resultant diameters of the ropes can be up to several micrometers in size. Thus, the effective diameter of single wall carbon nanotubes can be considered to be up to several micrometers in size. In another example, a bundle of carbon nanotubes has an effective aspect ratio in composites of the average length of the bundle divided by the bundle diameter. The curvature of the carbon nanotubes can be selected to obtain coatings of carbon nanotubes with different porosities and pore sizes.

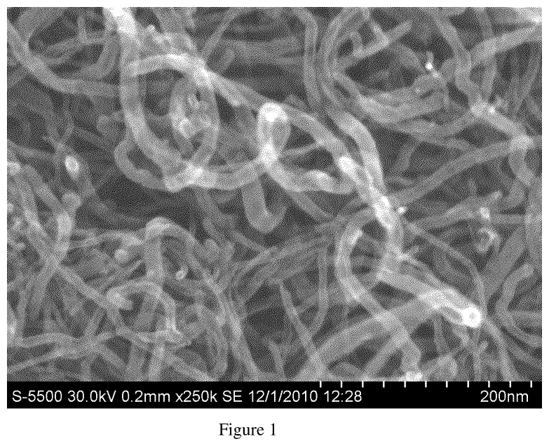

Theoretically one considers fusion between two polymer particles when polymer molecules have diffused across the interparticle boundary to a distance of at least 1 radius of gyration of the polymer. In practice this minimum value of the interparticle boundary of fused thermoplastics is usually in the range of 10 nanometers. Without going into the equations involving thermodynamics and viscosity with temperature and pressure for this diffusion phenomenon it is known practically that with low viscosity polymers in the melt, such as Nylon, this diffusion can occur quickly, i.e., seconds. The radius of gyration for nylon molecules is in the range of 4-5 nm. This radius of gyration value for nylon is well below the average mesh or pore size of the random multiwall carbon nanotube arrays as shown in FIG. 1, which means the low viscosity molten polymers should be able to flow through the discrete carbon nanotube porous mesh. Using bundles of carbon nanotubes where the size of the bundle is greater than about 2 micrometers would present great difficulty for polymer melts to flow through. The use of well-dispersed discrete carbon nanotubes allows them to uniformly coat particles or strands with coating thicknesses less than 2 micrometers. The surface of the carbon nanotube and the modification of the surface of the carbon nanotube when employed also has a key role to play for sintering polymer particles. If the thermodynamics or surface tension of the carbon nanotube surface or modified carbon nanotube surface is similar to the polymer particle being sintered and there is at least some voids then polymer permeation through the coating should be less hindered than if there was a large difference in the thermodynamics or surface tension. In some cases, the dispersant on the carbon nanotubes may be selected to be able to diffuse into the particle to be sintered.

The carbon nanotubes can be oxidized with oxidizing agents to provide carboxylic acid groups, hydroxyl groups, ketones and lactones with an overall (total) oxidation level of from about 0.1 weight percent to about 15 weight percent of the carbon nanotubes, preferably from about 0.5 weight percent to about 10 weight percent, more preferably from about 1 weight percent to 5 weight percent, more preferably from about 1 weight percent to 3 weight percent of the carbon nanotubes. Using a TA TGA Q50 instrument, the thermogravimetric method for the determination of the percent weight of oxygenated species on the carbon nanotube involves taking about 7-15 mg of the dried oxidized carbon nanotube and heating at 5° C./minute from 100 degrees centigrade to 700 degrees centigrade in a dry nitrogen atmosphere. The percentage weight loss from 200 to 600 degrees centigrade is taken as the percent weight loss of oxygenated species. The oxygenated species can also be quantified using Fourier transform infra-red spectroscopy, FTIR, particularly in the wavelength range 1730-1680 cm−1

The carbon nanotubes can also comprise oxygen containing species with molecular weight above about 100 daltons, such as, but not limited to polyethers, polyamides, polyurethanes, polyesters and polyketones. In these cases the amount of the oxygen containing species can be in the range of about 1 to about 80% by weight of the carbon nanotubes, preferably be in the range of about 1 to about 70% by weight of the carbon nanotubes, more preferably be in the range of about 2 to about 50% by weight of the carbon nanotubes and most preferably in the range of about 3 to about 50% by weight of the carbon nanotubes. Typically, the amount of discrete carbon nanotubes after completing the process of oxidation and shear is in the majority (that is, a plurality) and can be as high as 70, 80, 90 or even 99 percent of discrete carbon nanotubes, with the remainder of the tubes still partially entangled in some form. Complete conversion (i.e., 100 percent) of the nanotubes to discrete individualized tubes is most preferred. The carboxylic and hydroxyl groups can be used to react with a variety of chemical entities, such as but not limited to, amines, silanes, isocyanates, glycidyl, anhydrides, titanates, and acyl chlorides to provide other chemical modifications to the carbon nanotubes.

The discrete carbon nanotubes may further comprise a dispersing agent or surfactant, adhesively, ionically or covalently bonded to the discrete carbon nanotube surface. The surfactant may be a biocompatible surfactant. The surfactant molecule can be chosen such that the size of the surfactant molecule in the liquid media prevents it from entering within the discrete carbon nanotube. The selection of the minimum size of the surfactant molecule that cannot enter into a tube opening is related to the diameter of the tube opening and the hydrodynamic radius of the molecule in the liquid media.

The bundled or roped carbon nanotubes can be made from any known means such as, for example, chemical vapor deposition, laser ablation, and high pressure carbon monoxide synthesis. The bundled carbon nanotubes can be present in a variety of forms including, for example, soot, powder, fibers, and bucky paper. Furthermore, the bundled carbon nanotubes may be of any length, diameter, or chirality. Carbon nanotubes may be metallic, semi-metallic, semi-conducting, or non-metallic based on their chirality and number of walls. The discrete oxidized carbon nanotubes may include, for example, single-wall, double-wall carbon nanotubes, or multi-wall carbon nanotubes and combinations thereof. One of ordinary skill in the art will recognize that some of the specific aspects of this invention illustrated utilizing a particular type of carbon nanotube may be practiced equivalently within the spirit and scope of the disclosure utilizing other types of nanotubes such as those containing boron or nitrogen or silicon atoms. However, for control of the desired structures of a plurality of discrete carbon nanotubes requires a specific control of chemistry, thermal and mechanical energy which varies according to the starting structure of the carbon nanotubes.

One particular for forming carbon nanotubes of this invention is the incorporation of a portion of structures called Stone-Wales defects which are the rearrangement of the six-membered rings of graphene into heptagon-pentagon pairs that fit within the hexagonal lattice of fused benzene rings constituting a wall of the carbon nanotubes. These Stone-Wales defects are useful to create sites of higher bond-strain energy for more facile oxidation of the graphene or carbon nanotube wall. These defects and other types of fused ring structures may also facilitate bending or curling along the length of the carbon nanotubes.

Stone-Wales defects are thought to be more prevalent at the end caps that allow higher degrees of curvature of the walls of carbon nanotubes. During oxidation the ends of the carbon nanotubes can be opened and also result in higher degrees of oxidation at the opened ends than along the walls. The higher degree of oxidation and hence higher polarity or hydrogen bonding at the ends of the tubes are thought useful to help increase the average contour length to end to end ratio where the tubes are present in less polar media such as oil. The ratio of the contour length to end to end distance can be advantageously controlled by the degree of thermodynamic interaction between the tubes and the medium. Surfactants and electrolytes can be usefully employed also to modify the thermodynamic interactions between the tubes and the medium of choice. Alternate means to influence the ratio of contour length to end to end ratio include the use of inorganic or ionic salts and organic containing functional groups that can be attached to or contacted with the tube surfaces.

Carbon nanotubes are obtainable in the form of bundles, highly entangled agglomerates or ropes from different sources, such as CNano Technology, Nanocyl, Arkema, OCSiAl, LG Chem and Kumho Petrochemical. The carbon nanotubes are made using metal catalysts containing elements such as, but not limited to, iron, aluminum or cobalt, and can retain a significant amount of the catalyst associated or entrapped within the carbon nanotube, as much as about five weight percent or more. These residual metals can be deleterious in such applications as thermoplastic molding compounds where the metals cause accelerated thermal decomposition of the polymers or drug delivery, treatment, imaging, and/or diagnostics because of such residual metals may not be biocompatible. Furthermore, on oxidation of the carbon nanotubes these divalent or multivalent metal ions can associate with carboxylic acid groups on the carbon nanotube and interfere with the discretization of the carbon nanotubes in subsequent dispersion processes. Preferably, the oxidized carbon nanotubes comprise a residual metal concentration of less than about 25,000 parts per million, ppm, and preferably less than about 5,000 parts per million. The metals composition and concentration can be conveniently determined using energy dispersive X-ray spectroscopy or thermogravimetric methods.

An example of a method to produce discrete carbon nanotubes having targeted oxidation is as follows. A mixture of 0.5% to 5% carbon nanotubes, preferably 3%, by weight, is prepared with CNano grade Flotube 9000 carbon nanotubes and nitric acid. CNano Flotube 9000 carbon nanotubes are multiwall carbon nanotubes with an average diameter of 13 nm. The acid can also be a mixture of sulfuric acid and nitric acid. Preferably the initial nitric acid concentration is greater than about 65% nitric acid. Other oxidizing media such as, but not limited to potassium permanganate or hydrogen peroxide may be employed. The as-received CNano Flotube 9000 has a morphology similar to entangled balls of wool. While stirring, the nitric acid and carbon nanotube mixture is heated to 70 to 90 degrees C. for 2 to 4 hours. The formed oxidized carbon nanotubes are then isolated from the acid mixture. The oxidized carbon nanotubes are predominately in the form of entangled bundles. Several methods can be used to isolate the oxidized carbon nanotubes, including but not limited to centrifugation, filtration, mechanical expression, decanting and other solid-liquid separation techniques. The residual acid is then removed by washing the oxidized carbon nanotubes with an aqueous medium such as water, preferably deionized water, to a pH of 3 to 4. The carbon nanotubes are then suspended in water at a concentration of 0.5% to 4%, preferably 1.5% by weight. The solution is subjected to intensely disruptive forces generated by shear (turbulent) and/or cavitation with process equipment capable of producing energy densities up to about 10⁸ Joules/m³. Equipment that meets this specification includes, but is not limited to, ultrasonicators, cavitators, mechanical homogenizers, pressure homogenizers and microfluidizers. Typically, based on a given starting amount of entangled as-received and as-made carbon nanotubes, a plurality of discrete oxidized carbon nanotubes results from this process, preferably at least about 60%, more preferably at least about 75%, most preferably at least about 95% and as high as 100%, with the minority of the tubes, usually the vast minority of the tubes remaining entangled, or not fully individualized. A plurality of discrete oxidized carbon nanotubes is defined here as an amount of the oxidized discrete carbon nanotubes greater than 50% by weight of all the carbon nanotubes present. If desired, the oxidation, for example with acid, may be performed in the presence of a high energy mixer to give higher weight fractions of oxidized discrete carbon nanotubes before filtering and washing. Furthermore, after removal of the acid the catalyst residue originally present in the mixture as manufactured carbon nanotubes is reduced.

With single wall carbon nanotubes, the single wall carbon nanotubes are more difficult to obtain as discrete entities. This is because of the necessity to de-rope, e.g., separating strands into smaller strands and then forming the single wall carbon nanotubes. A convenient method to obtain discrete single wall carbon nanotubes is to utilize surface modifications to the single wall carbon nanotubes during high energy dispersion techniques. For example, oxidized discrete single wall carbon nanotubes are obtained by treating a 0.2% wt. suspension of single wall tubes (OCSiAl, Tuball) in 90% concentrated nitric acid at 90° C. for 3 hours while sonicating using a sonicator probe. After removal of the acid by filtering and washing to pH less than about 4, the oxidized single wall carbon nanotubes can be dispersed in water using surfactants such as, but not limited to, sodium carboxymethyl cellulose at weight ratios of surfactant to discrete single wall carbon nanotube where the porosity is greater than about 0.05 and less than about 0.95 in the dried coatings.

Material molding is a manufacturing technique wherein a feedstock material is formed under heat, pressure or surface tension in intimate contact with a rigid form, tool, or mold. Once the feedstock material conforms to the shape of the mold, the material is typically allowed to transition from a flowable or conformable plastic state to a non-flowable or rigid state. In the case of thermoplastic materials, this transformation may be accomplished by cooling the material causing it to transform into a glassy state or it may crystallize into a rigid or rubbery state. Alternatively, a powder, granular or pellet feedstock may be flowed into a mold cavity or applied as a surface coating and allowed to fuse or sinter the individual particles into a solid article, commonly known as rotomolding, slip casting, overmolding or compression molding. In addition to melt processable thermoplastics, thermoset polymer systems may be used in molding techniques wherein liquid, solid, or slurry-based feedstocks are introduced into a mold geometry and a chemical crosslinking, vulcanization, or other chemical bonding procedure is used to convert the material from a flowable or formable state to a non-flowable or formable state.

Powder bed fusion is one of seven Additive Manufacturing processes, in which either laser, heat, visible or infrared projected light, or electron beam is used to melt and fuse the material to form a three-dimensional object. The powder bed fusion printing category encompasses various techniques such as direct metal laser sintering (DLMS), selective laser melting (SLM), electron beam melting (EBM), selective laser sintering (SLS), multi jet fusion (MJF), selective heat sintering (SHS), or selective absorption fusion (SAF). All these methods fabricate the 3D object by fusion/melting of powdered feedstock.

Polymer powder bed fusion (a.k.a. Laser Sintering or LS) uses a laser to fuse thin layers of powdered polymer deposited across the build area by the leveling roller or a blade. The general LS process proceeds as follows: Control software slices the CAD model of the component to be built into individual cross-sectional layers. The build platform lowers one layer thickness; the powder supply indexes upwards to supply powder. A roller or blade picks up a portion of feedstock powder from the supply chamber and deposits it in a smooth layer over the build platform. The laser scans the cross-section of the component selectively melting the powdered polymer. A portion of the powder bed not irradiated by the laser energy remains a powder. The build chamber is moved down one layer thickness; the powder supply moves upward to deliver the next powder layer and the process repeats until the build is completed. The part(s) are removed from the powder bed and any un-sintered powder is brushed off. A common material used in polymer powder bed fusion processing is polyamide (nylons 11 and 12) obtainable from 3DChimera or Evonik industries. Other commercially available materials include, but not limited to, polyether block amides (PEBA), thermoplastic urethanes (TPU), thermoplastic elastomers (TPE), polypropylene (PP), aliphatic polyketone (PK) and high temperature polyaryletherketones (PAEK) which also includes polyetheretherketone, PEEK, polyetherketoneketone (PEKK) that are available from Arkema. These polymers are available in powder form from Formlabs. These polymers can also contain other particles known as fillers to improve certain properties such as stiffness. The particles or fillers within the polymer are, for example but not limited to, carbon black, graphene, graphene oxide, reduced graphene oxide, carbon nanotubes, carbon nanorods, glass fiber, glass flake, glass powder, glass beads, hollow glass spheres, mineral fillers and carbon fiber.

Multi jet fusion (MJF) is a powder bed fusion process technology introduced by HP in 2016. In the MJF process, the machine deposits a layer of powdered feedstock on the build platform and an inkjet printhead runs across the powder to deposit a fusing and detailing agent onto it. Then an infrared heating unit moves across the powder bed. The powder that was exposed to the fusing agent is melted and the powder exposed to the detailing agent remains intact. At the end of the build, the entire powder bed is transferred to a separate processing station where unfused powder is removed by vacuum. MJF compatible materials include polyamides 11 and 12, polypropylene, thermoplastic polyurethane (TPU), thermoplastic polyamide elastomer (TPA), and sinterable metal powders based on binder jet powder metallurgy.

Selective heat sintering (SHS) is an AM process that uses a thermal print head to solidify a powder, layer by layer, to create a 3D object. In SHS, powdered feedstock is heated to just below melting point and then spread onto the build platform using a roller. The thermal print head moves across the build platform and melts a cross sectional layer of the part. After the layer is complete, the build platform moves down one layer thickness and fresh layer of powder is deposited on top of previously fused layer. The process is repeated until the part is complete. The finished part is pulled from the build chamber and any unused powder can be reused.

Selective heat sintering is an AM process that uses a thermal print head to solidify a powder, layer by layer, to create a 3D object. In SHS, powdered feedstock is heated to just below melting point and then spread onto the build platform using a roller. The thermal print head moves across the build platform and melts a cross sectional layer of the part. After the layer is complete, the build platform moves down one layer thickness and fresh layer of powder is deposited on top of previously fused layer. The process is repeated until the part is complete. The finished part is pulled from the build chamber and any unused powder can be reused.

Selective absorption fusion is a polymer powder bed fusion process that uses piezo-electric print heads to deposit high absorption fluid onto a powder bed to define the area of the 3D object. The powder bed is then exposed to the infrared energy and the parts of the powder bed that have high absorption fluid absorb IR energy and are selectively fused to form a layer. Currently, SAF materials include polyamide 11 and 12.

Composite-based additive manufacturing (CBAM) is another AM process that uses powder as feedstock. It is fundamentally different from other powder-based technologies. CBAM uses carbon or glass sheet and powder to form sheet-fiber reinforced parts. The process begins with the deposition of the long-fiber sheets of carbon or fiberglass on the build platform. The layer of the part is deposited onto the fiber sheets using clear binding fluid and thermal inkjet technology. Next, the polymer powder is deposited on top and adhered to the printing fluid and the fiber sheet underneath. The excess powder is removed and recycled into the machine while the powder coated layer is left behind. The process is repeated for all subsequent layers. When all layers are deposited, the part is heated under load to the melting point of the polymer. The melted polymer particles encase the fibers and fuse the layers together. Then un-bonded portions of sheet fibers are moved through a mechanical or chemical process to reveal the final part. Polymers such as PEEK and polyamide 12 are currently used as matrix materials in CBAM process.

A common method for producing high volume polymer parts with material molding is thermoplastic polymer injection molding. In this method a feedstock of pellets or powder is fed into a hydraulically actuated screw plastification unit wherein the pellets are melted or softened into a flowable state under heat and pressure. The molten material can then be forced under high pressure to fill a mold cavity of the negative desired shape via a pathway of sprues and runners. The material cools as it packs the mold with material under high holding pressures to eliminate voids and defects in the parts. The cooled article is ejected from the mold cavity and another cycle is repeated. Thermoplastic injection materials commonly include amorphous polymers such as acrylonitrile butadiene styrene (ABS), high-impact polystyrene (HIPS), polystyrene (PS), polyphenylene oxide (PPO), modified polyphenylene oxide (mPPO), acrylonitrile styrene acrylate (ASA), polycarbonate (PC), polymethylmethacrylate (PMMA), polysulfone (PSU), polyphenylsulfone (PPSU), polyethersulfone (PESU), polyetherimide (PEI), polyamide-imide (PAI), and polyimide (PI), as well as semicrystalline resins including high density polyethylene (HDPE), polypropylene (PP), cyclic olefin copolymer (COC), polyamide (PA), polyethylene terephthalate (PET), polybutylene terephthalate (PBT), polyphthalamide (PPA), polyphenylene sulfide (PPS), liquid crystal polymer (LCP), polytetrafluoroethylene (PTFE), polyvinylidene fluoride (PVDF), polyetheretherketone (PEEK), and polyetherketoneketone (PEKK). These polymers can also contain other particles known as fillers to improve certain properties such as stiffness. The particles or fillers within the polymer are, for example but not limited to, carbon black, graphene, graphene oxide, reduced graphene oxide, carbon nanotubes, carbon nanorods, glass fiber, glass flake, glass powder, glass beads, hollow glass spheres, mineral fillers and carbon fiber.

Another common material molding process is compression molding. In this method feedstock material in powder, pellet, granulate, strand, sheet or pucks is placed into a heated mold cavity generally with excess material while pressure is applied to close the mold cavity causing the material to both soften and flow into the enclosing cavity. Once the material has packed the mold and conformed to the desired shape, the mold is cooled and the rigid or set part is removed from the mold cavity.

Hollow thin wall articles may be molded with a rotational molding (rotomolding) technique. In this method an open mold cavity is filled with less than 100% of the volume of the cavity with a polymer feedstock, generally powder or micropellets. The mold is tumbled in all directions while the mold surface is heated causing the feedstock material to stick and fuse in an even coating to the inside wall of the mold. Once all the feedstock is fused or the desired thickness is achieved the mold is cooled down and the solidified part is removed from the mold cavity.

Blow molding is a sheet forming process wherein a tubular polymer extrudate is directed into a mold cavity while a jet of pressurized air is applied to the inlet of the molten tube forcing the soft tube to expand up against the inside walls of the mold cavity.

Thermoforming is another sheet forming method where a thin planar sheet of plastic is heated, typically with infrared lamps, to the softening point of the polymer which is then draped over a vacuum forming plate with a mold geometry. Once the softened sheet seals against the vacuum plate the material is sucked into contact with the mold surface where it conforms and cools to the mold geometry.

Extruded profiles are a linear molding technology where feedstock thermoplastic materials are pumped with a melt screw through a heated extrusion die that shapes the extrudate to the shape of the die orifice.

The powders or strands for AM or molding of articles can be coated with compositions comprising discrete carbon nanotubes of this invention by such means as, but not limited by, creating a slurry of the powder and dispersions of the discrete carbon nanotubes in a liquid medium followed by drying, or spraying the dispersion of discrete carbon nanotubes in a liquid medium onto the powder or strand and drying. Other coating techniques such as dry coating followed by a fusing step in a heated fluidized bed, electrostatic deposition coating, liquid electrodeposition coating, or in-situ growth coating may be utilized. In the case of strands, including micro-strands with diameters between about 25-100 microns used for power production, or filaments with diameters between about 1-3 mm, the strands may be coated with a porous discrete nanotube solution or ink during the extrusion of the strand. Additionally, for AM, any coating method may be utilized in a raw feedstock manufacturing operation, or within and during the printing process to form a coating at the time of printing. Preferably the coating conditions such as the amount of powder in the slurry and concentration of discrete carbon nanotubes and temperature is chosen to control the quality of coating, the amount of coverage of the particle or strand surface with discrete carbon nanotubes, and the thickness of the dried coating. In particular, it is desirable to prevent significant amounts of powder agglomeration during the coating process. By maintaining porosity within the discrete carbon nanotube coating the inter-particle adhesion during the drying process can be better controlled. Notwithstanding, a variety of powder deagglomeration or sieving steps may be implemented to ensure a free-flowing powder feedstock is supplied to the printer used in AM.

The general purpose of the systems and methods disclosed herein is to provide novel compositions for producing additive manufacturing selective laser sintering particles or powders with coatings of discrete carbon nanotubes. The coatings have selected a range of porosity and optionally selected surface modifications, to improve sintering, wetting or flow of material through the pores of the carbon nanotube coating. Furthermore, the coatings of carbon nanotubes comprise less than about 20% of the mass of the coating in the form of highly entangled bundles or ropes of carbon nanotubes wherein the bundles or ropes of carbon nanotubes have at least one dimension of size larger than about 2 micrometers. This composition is designed to work in conjunction with a large variety of additive manufacturing processes and techniques.

Convenient analysis tools to measure the porosity are scanning electron microscopy or mercury porosimetry. Mercury porosimetry is based on the intrusion of mercury into the porous structure of a material through the application of isostatic pressure. The technique is based on the Washburn equation. This equation relates the pressure applied to the diameter of the pore into which the mercury is introduced. Mercury porosimetry provides information on pores with a range of size from about 900 microns to about 4 nanometers in diameter.

In one non-limiting embodiment, a composition of matter is configured for additive manufacturing to form coatings by virtue of its component elements or a combination of component elements comprising the composition of matter. One general aspect includes a composition for additive manufacturing. The composition also includes coatings of a thickness from about 5 nanometers to about 2000 nanometers on particles of diameter less than about 1000 micrometers where the coating is selected from the group of discrete carbon nanotubes. Other embodiments of this aspect include corresponding coatings configured to perform the actions of the composition.

Implementations may include one or more of the following features. The composition where the particles are selected from the group of organic polymers and inorganic species. The organic polymers are selected from the group of elastomers with a glass transition temperature below about 25 degrees centigrade, and polymers with a glass transition temperature above about 25 degrees centigrade. The inorganic species are selected from the group consisting of ceramics, silicates, metals, metal oxides, metal salts and mixtures thereof. The coating has a porosity (porosity defined as void fraction or that fraction of open space relative to the whole volume of the carbon nanotube coating) of about 0.05 to about 0.95, preferably from about 0.1 to about 0.8, more preferably from about 0.25 to about 0.75. The discrete carbon nanotubes are selected from a group of single wall, double wall or multiwall carbon nanotubes and mixtures thereof. The modality of aspect ratio of the discrete carbon nanotubes can be monomodal or at least bimodal. The carbon nanotubes are of length greater than about 0.2 micrometers. The discrete carbon nanotubes are preferably uniformly dispersed with less than about 20% of the mass of the carbon nanotubes present in the coating in the form of bundles or ropes of carbon nanotubes on a dimension scale larger than about 5 micrometers, more preferably less than about 5% of the mass of the carbon nanotubes present in the coating in the form of bundles or ropes of carbon nanotubes on a dimension scale larger than about 5 micrometers, and most preferably with less than 1% of the mass of the carbon nanotubes present in the coating in the form of bundles or ropes of carbon nanotubes on a dimension scale larger than about 5 micrometers. The composition may include carbonaceous material selected from the group of carbon black, carbon fibers, graphite, graphene, reduced graphene, carbon nanorods and graphene oxide. The ratio of discrete carbon nanotubes to carbonaceous material selected from the group of carbon black, carbon fibers, graphite, graphene, reduced graphene, carbon nanorods and graphene oxide is in the range about 1:99 to about 99:1 by weight. A part made by sintering particles, powders or strands with the coating compositions has a surface resistance of less than about 10 billion ohms. Implementations of the described techniques may include a variety of compositions or a method or process of preparing or applying the composition.

One general aspect includes a composition for additive manufacturing. The composition also includes coatings of a thickness from about 5 nanometers to about 2000 nanometers on particles of diameter less than about 1000 micrometers where the coating is selected from the group of discrete carbon nanotubes may include surface modification of the discrete carbon nanotubes. Other embodiments of this aspect include corresponding compositions of matter configured to perform the actions of the methods.

Detailed references will now be made to the embodiments of the present invention. One embodiment comprises a composition of matter configured for AM or injection molding feedstock coatings of thickness from about 5 nanometers to about 5 micrometers on particles of diameter less than about 5 millimeters for injection molding and for AM about 5 nanometers to 2000 nanometers on particles of diameter less than about 1000 micrometers or polymer strands wherein the coating is selected from the group consisting of discrete carbon nanotubes. Preferably the coatings selected from the group comprising discrete carbon nanotubes having a thickness from about 5 to 1000 nm and more preferably from about 5 to 500 nm.

In some embodiments the coatings are applied to particles of diameter less than about 1000 micrometers or polymer strands, pellets, or filaments. In some embodiments the particles are approximately spherical. In some embodiments the particles are hollow. In some embodiments the particles are irregularly shaped. In some embodiments the particles have a dumbbell shape. In some embodiments the particles are strands or fibers. In some embodiments the coating is applied to continuous polymer strands such as, but not limited to those strands made by polymer extrusion. In some embodiments the particle shapes are plates. In some embodiments the particle shapes are pellets or micro-pellets.

In some embodiments the discrete carbon nanotubes may comprise single wall tubes, double wall tubes, multi-wall tubes or a combination thereof.

In additional embodiments the particles or strands may include organic polymers. In some embodiments the particles may comprise inorganic species. In some embodiments the organic polymers may comprise elastomers with a glass transition temperature below about 25° C., and polymers with a glass transition temperature above about 25° C. The polymers may be linear molecules, branched molecules, homopolymers, random copolymers, block polymers or combinations thereof. The polymers may be thermoplastic or thermoset. Inorganic species may comprise ceramics, silicates, metals, metal oxides, metal salts and mixtures thereof.

In some embodiments the coating may comprise a porosity (porosity defined as void fraction or that fraction of open space relative to the whole volume) of about 0.05 to about 0.95.

In a further embodiment the carbon nanotubes are of length greater than about 0.5 micrometers.

In another embodiment the modality of aspect ratio of the discrete carbon nanotubes is monomodal, bimodal or multimodal.

In yet another embodiment the composition may comprise carbonaceous material. In some embodiments the carbonaceous material may be selected from the group comprising carbon black, carbon fibers, graphite, graphene, reduced graphene, and graphene oxide. The ratio of discrete carbon nanotubes to carbonaceous material selected from the group of carbon black, carbon fibers, graphite, graphene, reduced graphene, and graphene oxide is in the range about 0.1:99.9 to about 99.9:0.1 by weight. Preferably the ratio is about 0.25:1 to 99.9:01, more preferably the ratio is about 0.5:1 to about 99.9:0.1 and most preferably in the ratio of 0.75:1 to 99.9:0.1.

In yet another embodiment the coating comprises discrete carbon nanotubes that are uniformly dispersed onto the particle or strand with less than about 20% of the mass of the coating in the form of entangled bundles or ropes of carbon nanotubes wherein the bundles or ropes of carbon nanotubes have at least one dimension of size larger than about 5 micrometers. Preferably the mass of the coating in the form of entangled bundles or ropes of carbon nanotubes wherein the bundles or ropes of carbon nanotubes have at least one dimension of size larger than about 5 micrometers is less than about 20% and more preferably less than about 5% of the weight of carbon nanotubes. Even more preferably the mass of the coating in the form of entangled bundles or ropes of carbon nanotubes wherein the bundles or ropes of carbon nanotubes have at least one dimension of size larger than about 5 micrometers is less than about 20% and most preferably less than about 5% of the weight of carbon nanotubes.

In another embodiment the coating composition may comprise surface modification of the discrete carbon nanotubes. The surface modifications may comprise functionalizing the surface of the carbon nanotubes to improve the ability of the coated particles to sinter or to flow and fuse. In some embodiments the modifications may comprise functionalizing the surface of the carbon nanotubes to improve the ability of the coated particles to laser singer or form homogenous injection molded articles.

In some embodiments parts made using the coatings of this invention produce parts with enhanced properties, such as, but not limited to, mechanical, thermal, electrical, magnetic and chemical properties and improve process requirements such as, but not limited to, high energy absorption, flowability, and high green strength.

In some embodiments the carbon nanotube coating is modified to improve the bonding between particles sintered together into a part. In some embodiments the carbon nanotube coating surface is modified to bond to the particle.

In some embodiments a surface modification is attached to the surface of the discrete carbon nanotubes by covalent, ionic or hydrogen bonding. In some embodiments the composition disclosed herein further comprises the discrete carbon nanotubes with further at least one surface modification comprising molecules containing oxygen, silicon, titanium, zirconium, sulfur, phosphorous or nitrogen.

In some embodiments the surface modification comprises anionic, cationic, nonionic and zwitterionic surfactants, polyvinyl alcohols, copolymers of polyvinyl alcohols and polyvinyl acetates, polyvinylpyrrolidones and their copolymers, carboxymethyl cellulose, carboxypropyl cellulose, carboxymethyl propyl cellulose, hydroxyethyl cellulose, polyetherimines, polyethers, starch, and mixtures thereof.

In some embodiments the surface modification disclosed herein has a value of Hansen Solubility Parameter dispersion parameter within about 2 J^{0.5} m^{-1.5} the value of the Hansen Solubility Parameter dispersion parameter of the particle or strand. In some embodiments the surface modification is miscible with a polymer comprising the particle or strand. In some embodiments the surface modification allows chemical interaction between the composition of the particle and the surface modification.

Some embodiments comprise a method of modifying the surface comprising at least partially removed, or partially modified, during sintering of the particle.

In one other embodiment a part sintered from particles or strands coated with the coating disclosed herein comprises a surface resistance of less than about 10 billion ohms.

Powders or pellets with porous discrete carbon nanotube coatings may have extended uses beyond just laser sintering feedstock materials. In other additive manufacturing embodiments, the coated powders or pellets could be utilized in an auger, plunger, or screw-fed pellet extruder. In these applications the feedstock material undergoes mostly extensional flow during the deposition process, so such coatings may not become mixed homogeneously in the extruded beads but rather retain a cellular coating network that promotes electrically conductive networks at ultra-low (<1 wt %) loading levels. In other embodiments, thicker coatings may be applied to powdered feedstocks and extrusion processes with more mixing capacity are included to purposefully blend the coating into the melt phase with a high degree of homogeneity for improved dispersive and distributive mixing. Such methods may favor bulk material properties with enhanced physical properties due to the reinforcing effect of the discrete carbon nanotubes blended throughout the polymer matrix.

Other polymer, metal, or ceramic manufacturing processes may benefit from the discrete carbon nanotube coatings described in the present invention. For instance, other polymer molding techniques that rely on sintering of powder particles such as rotomolding, could directly use the discrete nanotube coated feedstock materials. Coated powders or micropellets could also be compounded in a twin-screw extruder to produce pellet feedstock with enhanced nanotube dispersion in the final product. Coated metal or ceramic particles could be used directly in traditional powder sintering processes such as slip casting or metal injection molding (MIM) and ceramic injection molding (CIM) workflows. Discrete nanotube coated polymer powders may find additional uses as advanced coatings. Examples include electrostatic powder coating feedstocks with tunable interactions with the electric field to improve coating uniformity, coating density, to enhance infrared or electromagnetic absorption and self-heating to cure or bond power coatings to the substrate, enhanced adhesion, coating durability, corrosion resistance, or improved electrostatic dissipation or electromagnetic shielding capabilities. Coated powders could also be utilized in fluid-based coating processes such as electrodeposition coatings (E-coatings) to improve particle migration rates to the substrate, improve coating uniformity and thickness control especially for thick coatings where insulating particles my inhibit or shield the charge on the article as film thickness increases.

In addition to feedstock material coatings, the present invention may be applied to secondary fillers or reinforcing agents added to the primary composition of a polymer, ceramic or metal matrix composite. Such fillers include, but are not limited to, glass fibers, glass spheres, glass beads, glass flake, woven or non-woven glass sheets, carbon fiber, basalt fibers, mica, talc, kaolin, clay wollastonite, calcium carbonate, natural fibers, boron nitride, graphite, and metallic wires. Discrete porous nanotube coatings applied to such fillers may enhance the electrical conductivity, filler-matrix adhesion, inhibit corrosion, or improve thermal transfer between filler particles. Coated secondary fillers have broad applications in both additive manufacturing and traditional manufacturing feedstock materials.

It is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

### EXAMPLES

### Example 1. Coating of an Elastomeric Block Polymer of Nylon 12 and Poly(Tetramethylene Oxide), Vestasint 3045D.

The polymer structure of Vestasint 3045D is considered to consist of a minor block polymer phase of Nylon 12 of whose domains are crystallized by about 20-30% wt. of the Nylon 12, and a major polymer phase of blocks of poly(tetramethylene oxide) which may also has some small amount of crystallinity. The elastomeric behavior of the article made from Vestasint 3045D stems from a major portion of the poly(tetramethylene oxide) which has a glass transition temperature <−50° C. effectively crosslinked by nanoscale domains of the semi-crystalline Nylon 12.

Dispersion of Oxidized Discrete Multiwall Carbon Nanotubes with Polyvinylpyrrolidone, PVP.

Discrete oxidized multiwall carbon nanotubes were made from CNano Flotube 9000 using nitric acid (65% nitric acid concentration) at a reaction temperature of 90 degrees centigrade and 2.5 hours, followed by removal of the acid by filtering, and washing by deionized water to a pH of 3.5. The oxidized carbon nanotubes were then subjected to intensive mixing in a slurry with water to give discrete oxidized carbon nanotubes. The amount of oxidized species of the functionalized carbon nanotubes was determined as 2.3% by weight using the thermogravimetric analysis (TGA) method detailed previously. An electron micrograph of a dried sample of the discrete oxidized multiwall carbon nanotubes is shown in FIG. 1 demonstrating the porosity of the discrete oxidized carbon nanotubes and the presence of many open ends within the discrete oxidized carbon nanotubes.

A 3% wt. oxidized discrete carbon nanotube dispersion was made by taking 20.45 g of 4.4% solids aqueous wet cake of the above oxidized discrete multiwall carbon nanotubes and adding 9.55 g of 0.45 g of polyvinylpyrrolidone, PVP 10,000 Daltons dissolved in 9.15 g water in a 50cc glass bottle. The weight ratio of PVP to discrete carbon nanotubes is 0.5 to 1. The bottle and contents were then sonicated using a sonicator bath for 3 hours keeping the temperature under 40° C. This process is repeated to make larger volumes for coating the powders as needed. The polyvinylpyrrolidone of molecular weight 10,000 daltons is selected as it has compatibility with the Vestasint. The Hansen Solubility Parameters for the dispersion, polar and hydrogen bonded components for PVP are 17.4, 8.8 and 14.9, respectively. For Nylon 12 the dispersion, polar and hydrogen bonded components of the Hansen solubility parameters are 18.5, 8.1 and 9.1, respectively.

### Coating of Vestasint 3054D Powder.

The appropriate weight of discrete oxidized carbon nanotubes in dispersion was added to make a range of coating thicknesses on 60 g total of coated powder. The range of discrete carbon nanotubes to polymer was 0.05 to 2% by weight. Water was added to make a total weight of 130 g and the slurry was mixed in a Thinky mixer at 2000 rpm for 3 minutes. The slurry was then spread thinly in a glass tray and dried at 100° C. for four hours in a convection oven.

### Differential Scanning Calorimetry, DSC

Differential scanning calorimetry, DSC, was performed using a TA DSCQ20 instrument, by first placing about 10 mg the coated pellets in the DSC pan, heating to 180° C. at 10° C./min, then cooling to −100° C. at 5° C./min followed by reheating to 180° C. at 10° C./min. The glass transition temperature, peak melting point, endotherm of melting, peak temperature of recrystallization and exotherm of recrystallization were recorded. The heat of fusion for 100% crystalline nylon 12 was taken as 246 J/g.

Optical pictures of the powders before and after sintering were taken using an optical microscope fitted with a Nikon digital camera.

Secondary electron microscopy, SEM, was performed on the powders to determine the nature of the coating. The powders were pressed onto sticky carbon discs placed on aluminum stubs. A typical electron beam energy of 2 or 5 KV was selected with a working distance of around 9 mm.

The Vestasint 3054D particle diameter ranged from about 30-150 micrometers with about 70 micrometers being the median value. The coating thicknesses of discrete carbon nanotubes were estimated assuming an average 70 micrometers diameter spherical particle, the relative weight of the carbon nanotubes to the polymer and the packing density of the dried discrete multiwall carbon nanotube coating, taken to be 0.25 g/cc. The value of the packing density of the carbon nanotubes coated on particles can be gained from electron microscopy studies of microtomed sintered particles or by delamination of the coatings from the particles.

TABLE 1
Calculated thickness of discrete oxidized carbon nanotube coating.

| | Wt. % carbon nanotubes | | | | | |
|---|---|---|---|---|---|---|
| | 0.05 | 0.1 | 0.2 | 0.5 | 1.0 | 2.0 |
| Thickness nm | 22 | 45 | 92 | 232 | 463 | 926 |

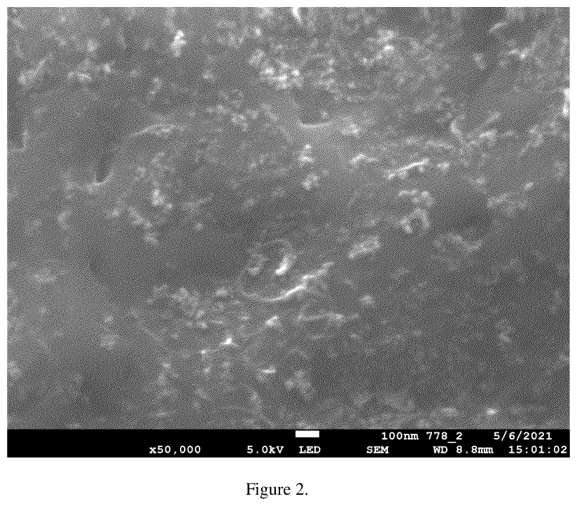

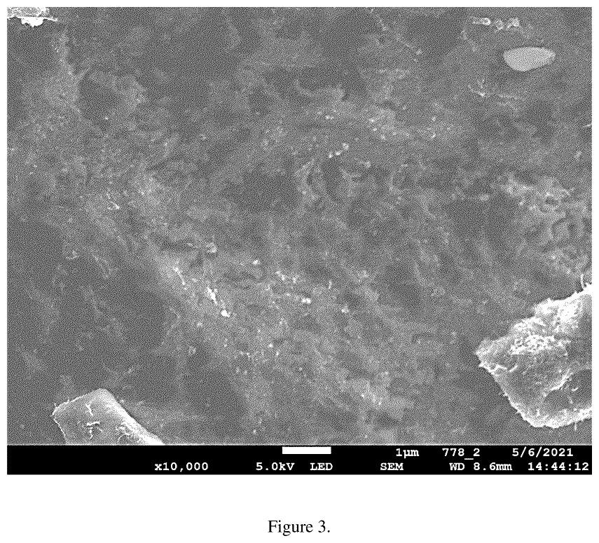

FIG. 2 shows an electron micrograph at 50,000 magnification of a monolayer of discrete oxidized carbon nanotube coating on a powder particle of Vestasint 3054D. The polyvinylpyrrolidone is seen as globules approximately 20 to 40 nanometers in diameter at the tube surface. The globular nature of the PVP shows that it has not formed a continuous coating, i.e., porosity with the discrete carbon nanotube is maintained. FIG. 3 shows the discrete carbon nanotube coating at 0.1% wt. discrete carbon nanotubes.

Nylon 12 polymer itself has a glass transition temperature, Tg, around 50° C. and a melting peak at 175° C. With the lower molecular weight of the block nylon 12 in Vestasint compared to homopolymer Nylon 12 the melting point is expected to be decreased and the Tg can be lowered also compared to the homopolymer nylon 12.

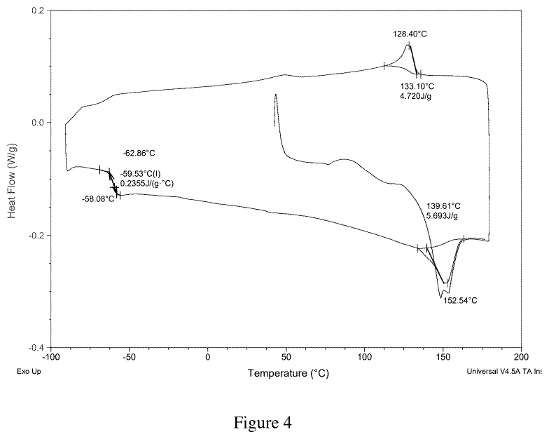

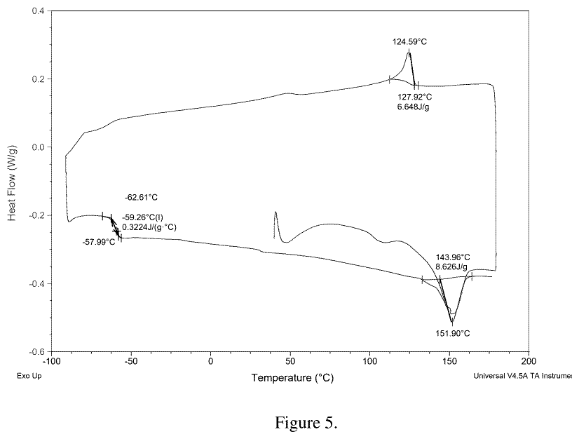

FIGS. 4 and 5 show thermograms of the heat-cool-heat cycle for uncoated and coated Vestasint 3054D, respectively. The differential scanning calorimeter thermogram of the first heating cycle seen in FIG. 4 shows that particle fusion is complete on melting of the particles starting around 140° C. On cooling the peak temperature of crystallization of the nylon 12 domain occurs at 128° C. for the Vestasint with no discrete carbon nanotube coating and around 125° C. with 2% weight of the discrete carbon nanotube coating, FIG. 5.

Another small thermic event occurs at around 50° C. on cooling. On reheating there is a small endothermic event, named Tm1 in Table 2, in the range 35 to 41.5° C. These two events on cooling and heating are due to the Tg of the nylon phase and/or small amounts of crystallization of the poly(tetramethylene oxide). The Tg, on heating is shown as around −58° C. is ascribed to the largely amorphous PTMO phase, then melting of the nylon 12 block with peak melting temperature around 152° C. The results of specimen for the 1^{st} cooling and 2^{nd} reheating are given in Table 2.

TABLE 2
Collected DSC data of Vestasint 3054D particles, uncoated and coated.

| % wt. | Tg | Tm1 | Tmpeak | ΔHm | Tc | ΔHc |
|---|---|---|---|---|---|---|
| coating | ° C. | ° C. | ° C. | J/g | ° C. | J/g |
| 0 | −58.1 | 41.5 | 152.5 | 5.7 | 128.4 | 4.7 |
| 0.05 | −58.0 | 41.5 | 153.8 | 9.3 | 128.4 | 7.6 |
| 0.1 | −58.3 | 41.5 | 152.8 | 9.3 | 128.1 | 7.6 |
| 0.2 | −57.4 | 35.4 | 153.2 | 9.6 | 127.2 | 7.9 |
| 0.5 | −57.6 | 35.4 | 152.9 | 9.5 | 126.7 | 7.7 |
| 1 | −58.0 | 35.4 | 150.3 | 9.6 | 125.6 | 7.8 |
| 2 | −59.9 | 35.4 | 151.9 | 8.6 | 127.9 | 6.6 |

Seen from the values of the heat of fusion on melting ΔHm and heat of fusion on recrystallization ΔHc in Table 2, the coating of oxidized discrete carbon nanotubes clearly increases the amount of crystallinity of the Nylon 12 domains.

The Vestasint 3054D particles with coatings of discrete oxidized carbon nanotubes in the range 0.05 to 2% weight of the particles were observed to be well fused together after heating to 180° C. The fused films were observed to decrease in the glossiness of the surface as the initial discrete carbon nanotube coating increased in thickness. With an interparticle coating thickness of about 2 micrometers the Vestasint polymer was still able to diffuse through the coating and make a coherent film.

### Example 2

Coating discrete oxidized carbon nanotubes onto Luvosint HTN particles. Luvosint HTN is a cryogenically ground high temperature semi-crystalline nylon copolymer made from hexamethylenediamine and isophthalic acid. The average particle diameter was determined as 73 micrometers. The oxidized discrete multiwall carbon nanotubes employed were the same as example 1.

An aqueous dispersion of 3% wt. oxidized discrete multiwall carbon nanotubes and 1.05% wt. polyvinylalcohol of Mw about 30,000 Daltons and hydrolysis value of about was made using a sonicator bath for 3 hours keeping the temperature under 40° C.

A series of coatings of 0.05, 0.1, 0.25, and 0.5 wt. oxidized discrete carbon nanotubes in the final dried material. The appropriate weight of the concentrated solution for coating 60 g of powder was added to water to make 70 g of solution, then added to 60 g of the Luvosint HTN. The slurry was hand mixed then mixed in a Thinky mixer at 2000 rpm for 3 minutes. The resulting mixture was spread thinly in a glass tray and dried at 100° C. for four hours in a convection oven, followed by 2 hours at 80° C. under vacuum. The powders were easily crushed with a glass bottle to give fine powders.

The coating thicknesses of the discrete carbon nanotubes were estimated assuming a 73 micrometers average diameter spherical particle, density of particle 1.14 g/cc and the packing density of the entangled discrete carbon nanotubes to be 0.25 g/cc.

TABLE 2
Calculated thickness of coating layer of discrete carbon nanotubes on
Luvosint HTN particles.

| | | | | |
|---|---|---|---|---|
| Weigh fraction of discrete | 0.05 | 0.1 | 0.25 | 0.5 |
| carbon nanotubes | | | | |
| coating thickness nm | 26 | 54 | 137 | 275 |

Secondary electron microscopy was performed on the powders to observe the coating. The powders were pressed onto sticky carbon discs placed on aluminum stubs. SEM pictures can be difficult to obtain because of electron charging on non-conductive polymers. Electron charging can give rise to smearing or waviness. Coatings of higher loadings were easier to image at high magnifications. A typical condition was 1 KV with a working distance of around 9 mm.

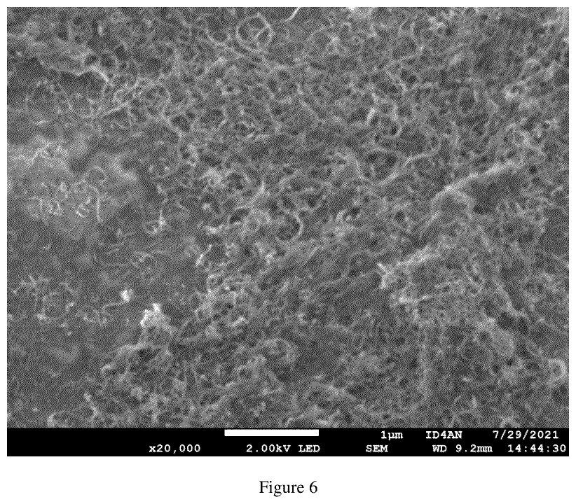

At 0.25% wt. of discrete oxidized carbon nanotubes coating on the powder, it was observed in some small regions of the surface of the particle that the carbon nanotube coating has separated from the Luvosint HTN, FIG. 6. Some discrete carbon nanotubes, however, remain adhered to the surface of the nylon where the thicker coating has been removed. This illustrates that polyvinylalcohol is suitable as a polymer surfactant for the dispersion of discrete carbon nanotubes as well as to provide adhesion of the discrete carbon nanotubes to the Nylon particle.

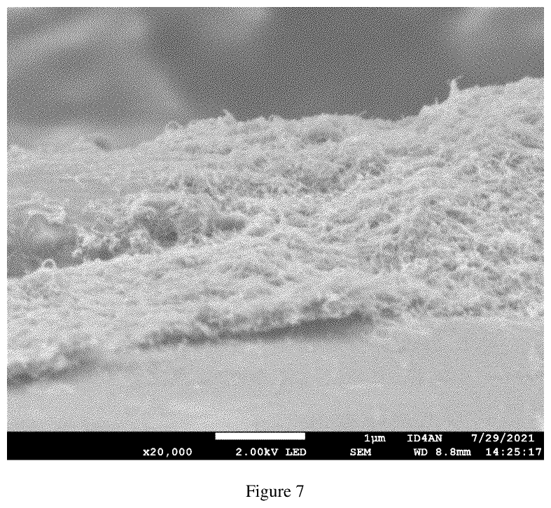

FIG. 7 shows the coating of 0.5% wt. discrete oxidized carbon nanotube and polyvinylalcohol coated powders where the particle was abraded to remove part of the coating and determine the coating layer thickness. The thickness of the coating was determined as 313 nm. The coating was also observed to be porous throughout the thickness.

DSC was performed by first placing about 10 mg of the coated pellets in the DSC pan, heating to 300° C. at 10° C./min, then cooling to 0° C. at 10° C./min followed by reheating to 300° C. at 10° C./min. The glass transition temperature, peak melting point, endotherm of melting, peak temperature of recrystallization and exotherm of recrystallization were recorded. The heat of fusion for 100% crystalline nylon was taken as 246 J/g. The glass transition temperature mid-point is 89.5° C. on reheating.

TABLE 3
DSC results

| % wt. discrete | | | | | |
|---|---|---|---|---|---|
| oxidized arbon | Tg ° C. | Tc peak | | Tm peak | |
| nanotube coating | 2^{nd} heat | ° C. | ΔHc J/g | ° C. | ΔHm J/g |
| 0 | 89.5 | 163.0 | 42.6 | 237.5 | 51.5 |
| 0.05 | 87.2 | 166.9 | 43.7 | 236.4 | 53.9 |
| 0.1 | 88.3 | 165.1 | 35.7 | 235.9 | 44.4 |
| 0.25 | 85.2 | 167.9 | 50.3 | 236.2 | 63.2 |
| 0.5 | 88.6 | 173.8 | 48.9 | 236.9 | 56.8 |

The DSC of the first heating cycle shows that particle sintering begins in the range 200° C. for the uncoated Luvosint HTN powder and the particle sintering slightly increases with discrete carbon nanotube coating content, going to about 205° C. for the 0.5% wt. coated powder. The values of the Tg and Tm peak are essentially the same independent of the coating in the range of discrete carbon nanotubes used here. The increasing Tc values are considered the result of the improved heat transport of the powders with discrete carbon nanotube coatings. The values of the heat of fusion would suggest a value for the % wt. crystallinity of 20-22%.

After sintering the particles at 300° C. the 0.05 and 0.1% wt. discrete carbon nanotube coated powders gave glossy surfaces whereas the 0.25 and 0.5% wt. discrete carbon nanotube coated powders were dull. In each case up to 0.5% wt. the coated powders gave a coherent film after cooling, i.e., the aromatic nylon permeated through the coating and gave good interparticle adhesion.

2-electrode resistance measurements using a digital ohmmeter (capable of measuring up to 20 megaohms) of the powders sintered on an aluminum plate gave values of 6 megaohms for the 0.25% wt. discrete oxidized carbon nanotube coating and 0.6 megaohms for the 0.5% wt. discrete oxidized carbon nanotube coating on Luvosint HTN particles.

### Example 3

Coating of Powders of Polyetherketone with Carbon Fiber Filler.

The polyetherketone has an estimated chopped carbon fiber content of 12% wt. The average particle size is taken as 70 micrometers. The oxidized discrete multiwall carbon nanotubes employed were the same as example 1.

An aqueous dispersion of 3% wt. oxidized discrete multiwall carbon nanotubes and 0.75% wt. polyvinylpyrrolidone of Mw about 40,000 Daltons was made using a sonicator bath for 3 hours keeping the temperature under 40° C.

A series of coatings of 0.05, 0.1, 0.15, 0.2, 0.25, 0.3, 0.35 and 0.4 wt. oxidized discrete carbon nanotubes to the PEK carbon fiber powders were made. The appropriate weight of the concentrated solution of discrete oxidized carbon nanotubes for coating 60 g of powder was added to water to make 70 g of solution, then added to 60 g of the powder. The slurry was hand mixed then mixed in a Thinky mixer at 2000 rpm for 3 minutes. The resulting mixture was spread thinly in a glass tray and dried at 100° C. for four hours in a convection oven, followed by 2 hours at 80° C. under vacuum. The powders were easily crushed with a glass bottle to give fine powders.

The coatings were observed to be uniformly coating the powders by optical microscopy. On sintering the particles using a hot plate, films with good mechanical integrity were obtained. At 0.25% wt. and higher loadings of the coating on the particle, after sintering the electrical resistivity of the surface was determined to be less than 10⁸ ohms, and suitable for making articles with electrostatic dissipation.

1. A composition for a coated particle comprising:
coatings of a thickness from about 5 nanometers to about 5000 nanometers on particles of diameter less than about 5000 micrometers wherein the particles comprise powders, pellets or polymer strands wherein the coating comprise discrete carbon nanotubes.

2. The composition of claim 1, wherein the particles are selected from the group consisting of organic polymers and inorganic species.

3. The composition of claim 2, wherein the organic polymers are selected from the group of elastomers with a glass transition temperature below about 25° C.

4. The composition of claim 2, wherein the organic polymers are selected from the group of polymers with a glass transition temperature above about 25° C.

5. The composition of claim 2, wherein the inorganic species are selected from the group comprising ceramics, cements, silicates, metals, metal oxides, metal salts and mixtures thereof.

6. The composition of claim 1, wherein the coating has a porosity of about 0.05 to about 0.95.

7. The composition of claim 1, wherein the discrete carbon nanotubes are selected from a group consisting of single wall, double wall or multiwall carbon nanotubes and mixtures thereof.

8. The composition of claim 1, further comprising carbonaceous material selected from the group of carbon black, carbon fibers, graphite, graphene, reduced graphene, carbon nanorods and graphene oxide.

9. The composition of claim 7, wherein the modality of aspect ratio of the discrete carbon nanotubes is monomodal.

10. The composition of claim 7, wherein the modality of aspect ratio of the discrete carbon nanotubes is at least bimodal.

11. The composition of claim 7, wherein the carbon nanotubes are of length greater than about 0.2 micrometers.

12. The composition of claim 7, wherein the discrete carbon nanotubes are dispersed with less than about 20% of the mass of the coating in the form of entangled bundles or ropes of carbon nanotubes wherein the bundles or ropes of carbon nanotubes have at least one dimension of size larger than about 5 micrometers.

13. The composition of claim 7, wherein the ratio of discrete carbon nanotubes to carbonaceous material selected from the group of carbon black, carbon fibers, graphite, graphene, reduced graphene and graphene oxide is in the range about 1:99 to about 99:1 by weight.

14. A composition for a manufacturing particles comprising:
coatings of a thickness from about 5 nanometers to about 2000 nanometers on particles of diameter less than about 1000 micrometers wherein the coating is selected from the group of discrete carbon nanotubes further comprising surface modification of the discrete carbon nanotubes.

15. The composition of claim 14, wherein the surface modification is attached to the surface of the discrete carbon nanotubes by covalent, ionic or hydrogen bonding.

16. The composition of claim 14, wherein the discrete carbon nanotubes further comprise a surface modification selected from the group consisting of molecules containing oxygen, silicon, titanium, zirconium, sulfur, phosphorous or nitrogen or any mixture thereof.

17. The composition of claim 15, wherein the discrete carbon nanotubes further comprise a surface modification selected from the group consisting of anionic, cationic, nonionic and zwitterionic surfactants, polyvinyl alcohols, copolymers of polyvinyl alcohols and polyvinyl acetates, polyvinylpyrrolidones and their copolymers, carboxymethyl cellulose, carboxypropyl cellulose, carboxymethyl propyl cellulose, hydroxyethyl cellulose, polyetherimines, polyethers, starch, and mixtures thereof.

18. The composition of claim 14, wherein the surface modification has a value of Hansen Solubility Parameter dispersion parameter within about 2 J^{0.5} m^{-1.5} the value of the Hansen Solubility Parameter dispersion parameter of the particle.

19. The composition of claim 14, wherein the surface modification is miscible with a polymer comprising the particle.

20. The composition of claim 14, wherein there is at least some chemical interaction between the composition of the particle and the surface modification.

21. The composition of claim 14, wherein the surface modification is at least partially removable, or partially modifiable.

22. The composition of claim 1, wherein the coating has a surface resistance of less than about 10 billion ohms.
